(19) United States
(12) Patent Application Publication
(10) Pub. No.: US 2003/0109288 A1
(43) Pub. Date: Jun. 12, 2003

(54) Remote configuration of alert mode parameters for portable electronic communication devices

(75) Inventors: Jeffrey A. Carley, Colorado Springs, CO (US); Mark D. Kelly, Whitefish Bay, WI (US)

Correspondence Address: WORLDCOM, INC., TECHNOLOGY LAW DEPARTMENT, 1133 19TH STREET NW, WASHINGTON, DC, 20036, US

(73) Assignee: WORLDCOM, INC.

(21) Appl. No.: 10/017,650

(22) Filed: Dec. 12, 2001

(51) Int. Cl. H04M 1/00

(52) U.S. Cl. 455/567; 455/445

(57) ABSTRACT

Method and apparatus for remote configuration of alert mode parameters of personal communication devices and, in particular, remote override of a silent or inaudible alert mode of the PCD.

### TECHNICAL FIELD OF THE INVENTION

The present invention relates in general to a method and apparatus that provides remote configuration of alert mode parameters for a portable electronic communication device.

### BACKGROUND OF THE INVENTION

Many electronic personal communication devices (PCDs) such as cellular telephones, pagers, personal digital assistants and two-way radios have options that can be configured by the user for the operation of the device. One example of such a user option is the ability to configure the device to provide either an audible mode for alerting the user of incoming calls or messages or an inaudible mode such as a flashing light or a vibrating element inside the PCD to alert the user of incoming calls or messages. The PCD typically has a number of user selectable alert modes. In this application the term “alert mode” refers to silent alert, do not disturb, audible alert, ringer volume high, medium, low, off, vibrate, inaudible alert, and the like. The alert mode may be configured by pressing a switch or by selecting a menu item on a display of the PCD. If the PCD is in an audible alert mode and the device is somehow misplaced, placing a call or page to the PCD so that it will provide an audible alert may, of course, be helpful in locating it. On the other hand, if the user misplaces the PCD while it is in an inaudible, silent, or do-not-disturb mode the unit will not generate an audible alert in response to a call or page and the help of the audible alert in locating the PCD will not be available. Thus, there is a need to provide assistance in locating the PCD when the PCD is not configured for generating an audible alert.

### SUMMARY OF THE INVENTION

The present invention addresses the foregoing problems, at least in part, as well as other problems, by providing for remote configuration of user selectable alert modes and parameters for the PCD. For example, if the PCD has been left in a non-audible alert mode, the PCD silent alert mode configuration can be updated from a remote source to an audible alert mode allowing for the PCD to be called or paged generating an audible alert from the PCD.

### BRIEF DESCRIPTION OF THE DRAWINGS

The above and other objects, features, and advantages of the invention will be apparent from the following more particular description of preferred embodiments of the invention, as illustrated in the accompanying drawings in which like reference characters refer to the same parts throughout the different views.

FIG. 1 is a diagram of a PCD according to an example of the present invention.

FIG. 2 is a simplified schematic diagram of a PCD according to an example of the invention.

FIG. 3 is a flow diagram of the operation of an example of the present invention.

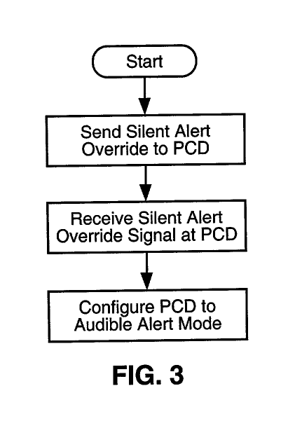

### DETAILED DESCRIPTION OF THE INVENTION

In the following detailed description of the preferred exemplary embodiments, reference is made to the accompanying drawings that form a part hereof, and in which is shown by way of illustration specific preferred exemplary embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention enable the remote override, unlocking or configuration of locally set alert mode parameters of a PCD. Overriding or remote configuration of the silent alert mode is presented in particular detail. In some embodiments, remote configuration may be accomplished by calling a central service to which the PCD is subscribed and changing alert mode parameters via a telephone menu. It is also possible to update the alert mode parameters by accessing a service provider's web server over the Internet. In other embodiments remote reconfiguration may be achieved through a direct link to the PCD such as by wireless transmission, or by voice activation.

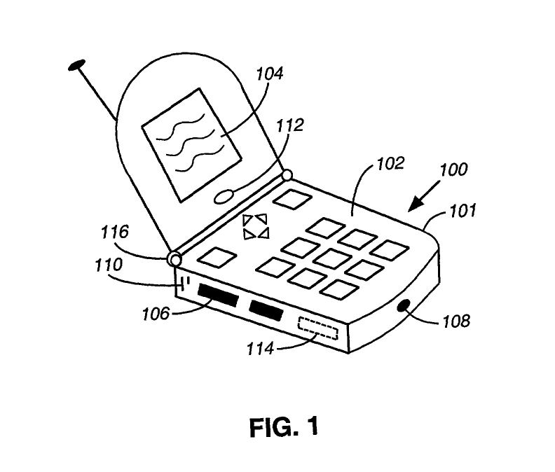

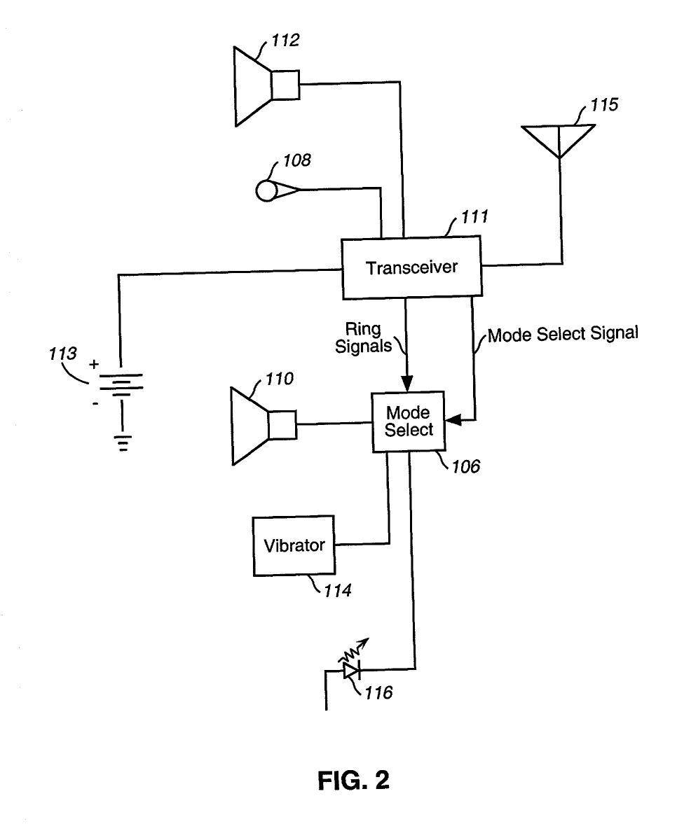

FIG. 1 shows a representative example of a PCD 100 according to the present invention. PCD 100 includes a housing 101, a keypad 102 for entering telephone numbers, data, and commands, and for scrolling through menus, a display 104 for displaying status information and menus, a selector 106 for selecting an alert mode, a microphone 108 for receiving a user's voice, a loudspeaker 112 for transmitting voice sounds to the user, an annunciator 110, such as a piezoelectric or electromagnetic transducer or ringer, for providing a variety of alert sounds such as a ring tone (which may, in some examples, be integral with loudspeaker 112), a transceiver 111 (shown in FIG. 2) for wireless transmission and reception of voice and other signals, and a power supply 113 (also shown in FIG. 2) for powering the PCD. PCD 100 may also include an inaudible alert device such as vibrating element 114 (shown in phantom). Vibrating element 114 provides a silent or nearly silent mechanical vibration that can be sensed by the user when PCD 100 is located, for example, in a pocket of a garment worn by the user or clipped to a belt. The alert provided by vibrating element 114 will not, in general, be audible to others. PCD 100 may also include an LED 116 for providing visual alerts to the user, such as providing an indication of when a new message may be waiting. In some examples of the present invention PCD 100 may be a pager-like device for receiving, displaying and announcing incoming messages and thus may not have the full bi-directional communication capability of the PCD illustrated in FIGS. 1 and 2.

Operation of a preferred exemplary embodiment of the present invention will now be described. When an incoming message or call is received, PCD 100 may issue an audible alert such as a ring sound or a beep, through annunciator 110. Alternatively, if PCD 100 is set to an inaudible alert state or mode, it may provide an inaudible alert through vibrating element 114 and/or LED 116, or it may provide no alert indication at all if the alert mode is set to “off” or “private time”. The alert mode may be selected by switch 106 or it may be selected from a menu shown on display 104.

Remote reconfiguration of the alert modes and parameters can be accomplished in a variety of ways. Voicemail systems associated with many PCDs allow users to call in from a wireline or other telephone and listen to messages after entering a security code. In one example, PCD 100 may include access to a voice mail or other subscriber dialup system that can be accessed by dialing an access number and entering a security code. The reconfiguration of the alert mode may be added as a feature to the subscriber dialup system. For example, an alert mode reconfiguration feature may be selected from a menu of setup options in the voicemail system. Selecting alert mode reconfiguration might also include setting the audible alert to a frequency and amplitude that would be most likely to be heard at a distance. After the user has elected to remotely modify the alert mode, a wireless signal will then be sent by the service provider to PCD 100 to reconfigure its user alert mode to the mode remotely selected by the user. The alert mode reconfiguration signal received over antenna 115 will be processed and decoded in transceiver 111. Transceiver 111 will provide an alert mode reconfiguration signal to mode select 106 to effect change of the transceiver 111 to the new alert mode.

Alternatively, reconfiguration of the alert mode may be activated by calling an operator. Upon verification of the user's identity, an operator may send alert mode reconfiguration signal to PCD 100 enabling PCD 100 to respond to incoming communications with the newly selected alert mode. The alert mode reconfiguration feature may also be activated through the Internet by a user access to a subscriber service provided for checking account status and configuration options and the like.

In another exemplary embodiment, the alert mode reconfiguration feature may include setting the ring sound to a frequency, amplitude and tone quality that would be most likely to be heard at a distance. In yet another exemplary embodiment, the alert mode reconfiguration feature may include setting the ring sound to a siren or alarm, in the event that the PCD has been stolen, for example. Additionally, the alarm or siren could be configured to ring continuously until the batteries are exhausted.

While in most embodiments, the alert mode reconfiguration signal will be a wireless radio frequency signal, in some applications the alert mode reconfiguration signal may be provided to PCD 100 by wireless inductive or capacitive coupling or infrared transmission, or the like. In other embodiments, PCD 100 may be programmed to recognize and respond to a user's verbal command to override or otherwise change the silent alert mode.

In another exemplary embodiment of the invention, PCD 100 may advantageously respond to an alert mode reconfiguration signal so that all PCDs at a particular location, such as a concert hall or theater, will automatically switch to a silent mode in response to a global command or by sensing that the PCD is in proximity to an alert mode reconfiguration signal. As soon as the user leaves the proximity of the alert mode reconfiguration signal, the PCD alert more may return to the setting previously configured by the user.

### CONCLUSION

A system, method, and apparatus for remotely configuring the alert modes and parameters of a PCD have been detailed. Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for remotely activating an audible alert mode for a personal communication device, comprising:
sending a signal to the personal communication device for remotely switching to an audible alert mode; and
switching from an inaudible alert mode to an audible alert mode in response to the signal.

2. The method for remotely activating an audible alert mode for a personal communication device of claim 1, wherein the signal is sent by a subscriber system to the personal communication device.

3. The method of claim 1, wherein the signal comprises a user's spoken command.

4. The method of claim 1, wherein sending a signal to the personal communication device for remotely selecting an audible alert mode is initiated by calling a subscriber dial-up system.

5. The method of claim 1, wherein sending a signal to the personal communication device for remotely selecting an audible alert mode is initiated by making a request through an operator assisted system.

6. The method of claim 1, wherein sending a signal to the personal communication device for remotely selecting an audible alert mode is initiated by accessing a subscriber system over the Internet.

7. The method of claim 5 wherein the operator is automated.

8. A method for remote configuration of the alert mode of a personal communication device, comprising:
sending a wireless alert mode configuration signal to the personal communication device;
receiving the wireless alert mode configuration signal by the personal communication device;
configuring the alert mode of the personal communication device in response to the wireless configuration signal.

9. The method of claim 8 wherein the wireless alert mode configuration signal is sent to the personal communication device by a subscriber service.

10. The method of claim 9 wherein the wireless alert mode configuration signal is sent to the personal communication device by an operator.

11. The method of claim 9 wherein the wireless alert mode configuration signal is sent to the personal communication device in response to a selection made in a subscriber system.

12. The method of claim 8 wherein the alert mode configuration is changed from an inaudible alert mode to an audible alert mode.

13. The method of claim 8 wherein the wireless alert mode configuration signal is sent to the personal communication device automatically when it is in a particular location.

14. A method for remote configuration of an alert mode of a personal communication device, comprising:
sending a wireless configuration signal to the personal communication device for reconfiguring the alert mode of the personal communication device;
receiving the wireless reconfiguration signal by the personal communication device;
reconfiguring the alert mode of the personal communication device in response to the wireless configuration signal.

15. The method of claim 14 wherein the wireless configuration signal is sent to the personal communication device by a subscriber service.

16. The method of claim 15 wherein the wireless configuration signal is sent to the personal communication device by an operator.

17. The method of claim 15 wherein the wireless configuration signal is sent to the personal communication device in response to a selection made in a subscriber system.

18. The method of claim 14 wherein the alert mode is reconfigured from an inaudible alert mode to an audible alert mode.

19. The method of claim 14 wherein the alert mode is configured to a siren or alarm.

20. The method of claim 19 wherein the siren or alarm is configured to annunciate until a power supply of the personal communication device is exhausted.

21. A portable communication device, comprising:
a wireless receiver for receiving communication signals;
an audible annunciator that provides alert sounds in response to one or more signals received by the wireless receiver;
a mode selector that selects between a plurality of alert modes;
wherein the alert modes may be remotely selected.

22. A portable communication device, comprising:
a wireless transceiver for sending and receiving communication signals;
an audible annunciator that provides alert sounds in response to one or more signals received by the wireless transceiver;
a mode selector that selects between a plurality of alert modes;
wherein the alert modes may be remotely selected.

23. A portable communication device, comprising:
a receiver for receiving wireless communications;
an annunciator for providing an audible alert when a communication is received; and
a mode selector that selects between a plurality of alert modes comprising an audible alert mode and an inaudible alert mode, wherein an alert mode may be selected in response to a wireless signal.

24. A portable communication device, comprising:
a wireless receiver;
an annunciator for providing an alert sound in response to a communication received by the wireless receiver;
a mode selector for selecting between a plurality of alert modes wherein the mode may be remotely selected.

25. The portable communication device of claim 24 wherein the alert mode may be remotely selected by telephone.

26. The portable communication device of claim 24 wherein the alert mode may be remotely selected by a wireless signal.

27. A portable communication device, comprising:
an audible annunciator;
a selector for selective deactivation of the audible annunciator in response to a user command, wherein the audible annunciator may be remotely reactivated.

28. The personal communication device of claim 27 wherein the audible annunciator may be reactivated by an operator.

29. The personal communication device of claim 27 wherein the audible annunciator may be reactivated by a voicemail system.

30. The personal communication device of claim 27 wherein the audible annunciator may be deactivated by an operator.

31. The personal communication device of claim 27 wherein the audible annunciator may be deactivated by a voicemail system.

32. A wireless communication system comprising:
a plurality of personal communication devices, wherein one or more of the personal communication devices comprises a transducer for providing an alert sound in response to a communication received by the wireless transceiver, a mode selector for switching between a plurality of alert modes wherein the mode selector may be remotely switched in response to a wireless alert mode select signal; and
a subscriber service that provides wireless alert mode select signals.

33. A wireless communication system comprising:
a plurality of personal communication devices, wherein one or more of the personal communication devices comprises a transducer for providing alert sounds, and further comprises a mode selector for switching between a plurality of alert modes, wherein the mode selector may be remotely switched in response to a wireless alert mode select signal; and
a wireless transmitter that provides wireless alert mode select signals to one or more of the personal communication devices.

34. The wireless communication system of claim 33 wherein the wireless transmitter is configured to provide the wireless alert mode select signals to the plurality of personal communication devices when they enter a particular location.

35. The wireless communication system of claim 33 wherein the wireless alert mode select signals override the alert mode selected by the user while the personal communication device is at the particular location.

36. The wireless communication system of claim 33 wherein the wireless alert mode select signals are provided by inductive or capacitive coupling.
